(19) United States
(12) Patent Application Publication
(10) Pub. No.: US 2021/0103997 A1
(43) Pub. Date: Apr. 8, 2021

(54) REAL ESTATE TECHNOLOGY PLATFORM

(71) Applicant: Thomas Zachary High, Winter Springs, FL (US)

(72) Inventor: Thomas Zachary High, Winter Springs, FL (US)

(21) Appl. No.: 17/061,184

(22) Filed: Oct. 1, 2020

Related U.S. Application Data
(60) Provisional application No. 62/909,825, filed on Oct. 3, 2019.

(51) Int. Cl. G06Q 50/16; G06Q 20/36; G06Q 20/38

(52) U.S. Cl. CPC G06Q 50/163; G06Q 20/3827; G06Q 20/36

(57) ABSTRACT

A real estate platform for transferring fractional ownership interests of real property over a network includes a plurality of interface devices and a platform provider environment comprising at least one computer system, at least one database, at least one distributed ledger environment. The platform generating interfaces to facilitate an initial purchase of real property from an original seller to the platform provider, along with the generation of asset-based tokens for the transferred property. The platform providing options for allowing system users to buy and sell fractional ownership of the transferred property via the tokens. Each token holder is granted a legal interest in the property, each transaction is recorded by a distributed ledger, and the original seller's ownership percentage diminishes as tokens are purchased. Fractional owners are provided with landlord options for managing and profiting from the subject property.

### CROSS-REFERENCE TO RELATED APPLICATIONS

This application claims the benefit of U.S. Application Ser. No. 62/909,825 filed on Oct. 3, 2019, the contents of which are incorporated herein by reference.

### TECHNICAL FIELD

The present invention relates generally to the real estate industry, and more particularly to a real estate technology platform for performing and facilitating fractional real estate ownership.

### BACKGROUND

Current methodologies for investing in commercial real estate are cumbersome, time consuming and costly. In the traditional investment model, investors must typically purchase the entire property, thus enduring long waiting periods to receive third party reports such as an appraisal, lender financing commitment, environmental reports, survey, and tenant documents, just to name a few. Moreover, each purchase results in significant brokerage fees thus making the process more costly.

As a result of the above there are very few, if any, commercially available options for individuals and/or small groups to invest in the commercial real estate market, as such person's often do not have the time or capital funds to pursue the traditional model.

Accordingly, it would be beneficial to provide a real estate technology platform and method of using the same in order to allow interested parties to purchase and invest in the real estate market via fractional ownership.

### SUMMARY OF THE INVENTION

The present invention is directed to a real estate platform for transferring fractional ownership interests of real property over a network.

One embodiment of the system can include at least one user interface device for operation by an original seller, at least one user interface device for operation by a site user, and a platform provider environment comprising at least one computer system, at least one database, at least one distributed ledger environment, and a communications network that is connected to each of the interfaces and systems.

The platform can function to establish communication between the various interfaces to facilitate a purchase of real property from an original seller to a platform provider representative. The purchase can include a transfer of legal title from the original seller to the platform provider and the generation of a plurality of asset-based tokens for the property. Each token holder can be granted a legal interest in the property, and the original sellers ownership percentage will diminish as tokens are purchased.

In one embodiment, the platform can provide a marketplace for allowing system users to research, buy and sell fractional ownership in a plurality of available real properties via the generated tokens, and each transaction can be memorialized through a distributed ledger system. The system can also grant fractional owners with landlord options for allowing the owners to manage the ongoing operation of the subject property, to earn rental income, and to enjoy property appreciation.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows one exemplary system of the real estate platform that is useful for understanding the inventive concepts disclosed herein.

FIG. 2 shows an exemplary flow diagram illustrating a method of selling and listing a subject property using the real estate platform.

FIG. 3A shows an exemplary user interface of the real estate platform, in accordance with one embodiment of the invention.

FIG. 3B shows an exemplary user interface of the real estate platform, in accordance with one embodiment of the invention.

FIG. 3C shows an exemplary user interface of the real estate platform, in accordance with one embodiment of the invention.

FIG. 3D shows an exemplary user interface of the real estate platform, in accordance with one embodiment of the invention.

FIG. 3E shows an exemplary user interface of the real estate platform, in accordance with one embodiment of the invention.

FIG. 3F shows an exemplary user interface of the real estate platform, in accordance with one embodiment of the invention.

FIG. 3G shows an exemplary user interface of the real estate platform, in accordance with one embodiment of the invention.

FIG. 4 shows an exemplary flow diagram illustrating a method of purchasing fractional ownership of a subject property utilizing the real estate platform.

FIG. 5A shows an exemplary user interface of the real estate platform, in accordance with one embodiment of the invention.

FIG. 5B shows an exemplary user interface of the real estate platform, in accordance with one embodiment of the invention.

FIG. 5C shows an exemplary user interface of the real estate platform, in accordance with one embodiment of the invention.

FIG. 6 shows an exemplary flow diagram illustrating a method of selling fractional ownership of a subject property utilizing the real estate platform.

FIG. 7A shows an exemplary user interface of the real estate platform, in accordance with one embodiment of the invention.

FIG. 7B shows an exemplary user interface of the real estate platform, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

Although described throughout this document as pertaining to the commercial real estate market and fractional ownership/investment in the same, this is but one possible implementation of the system. Accordingly, the system and methodology described herein can be applied toward many other forms of investments and/or ownership models without undue experimentation.

### Definitions

As described throughout this document, the terms “subject property” and “building” shall be used interchangeably to describe any piece of real property, land, building, and/or physical structure which can be bought, sold or possessed via use of the Platform.

The term “user” describes any person, group or legal entity who is utilizing the Platform to view, buy or sell fractional ownership title interests of a subject property.

The term “original seller” describes any person, group or legal entity who is selling or otherwise making a subject property available for purchase by users of the Platform.

The terms “platform provider” and “system management” are used interchangeably, and can include an individual, group or legal entity that is overseeing, providing and/or performing various aspects of the below described system and method steps which makes the Platform available.

The term “digital wallet” includes a user interface allowing users and/or platform providers to interact with a chain of data (Blockchain) by either controlling, storing, inputting, outputting and/or transferring data. In the preferred embodiment, data used by the below described system and method will be geared towards the Real Estate industry, and system users can access the system wallet by web address &/or downloading an application.

In one embodiment, the disclosed system and method can be performed in part, by a plurality of computer systems utilizing one or more websites to interface with users. In one preferred embodiment, the website can be www.FREXA.io, for example, but any number of different URL addresses are also contemplated. Additionally, it is contemplated that several different methods can be performed via the platform simultaneously using different websites that are directed towards different individual markets and/or geographic locales, for example. Such methods can be performed under the direct supervision of the original platform provider, or via secondary providers through a franchise, license or other form of legal agreement.

The below described system and method can provide a platform that functions to allow users to buy and sell whole and/or partial (fractional) ownership interests of a subject property using a peer to peer transfer mechanism and blockchain recording that eliminates traditional broker costs and streamlines ownership records. As will be appreciated by one skilled in the art, aspects of the present invention may be embodied as a system, method, and/or computer program product.

Accordingly, aspects of the present invention may take the form of an entirely hardware embodiment, or an embodiment combining software and hardware aspects that may all generally be referred to herein as a “unit”, “module,” “system”, or “feature.” Furthermore, aspects of the present invention may take the form of a computer program product embodied in one or more computer readable medium(s) having computer readable program code embodied thereon, while other aspects may utilize traditional mechanisms for conducting voice communications. In either instance, the system and other computer hardware will be necessary to facilitate the transfer of fractional ownership in subject properties.

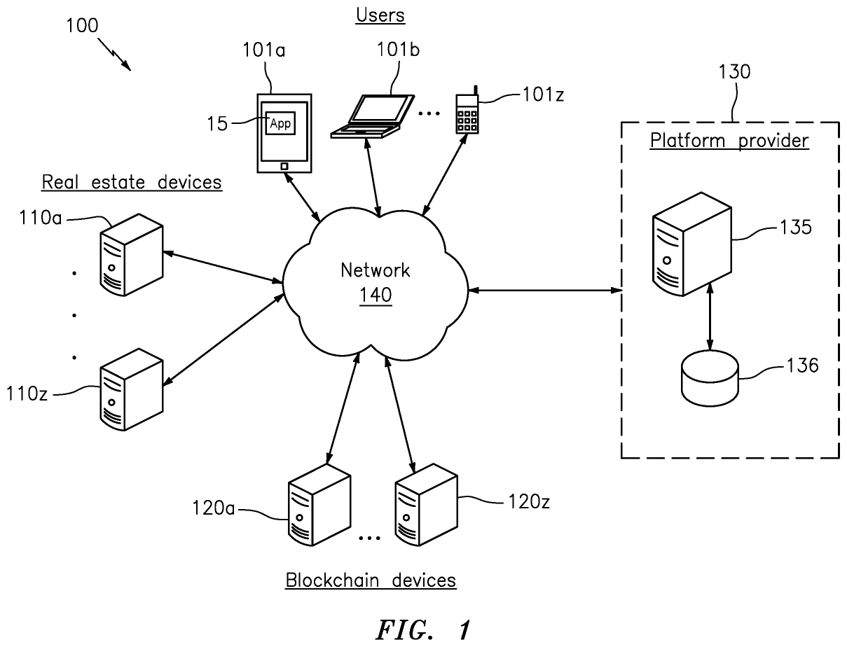

FIG. 1 is a schematic illustration of an exemplary system operating environment 100 for establishing a peer to peer Real Estate platform for performing a method of allowing users to upload, buy, sell and manage real property. The system 100 can include, for example, a plurality of users each utilizing a user interface device 101a-101z, any number of real estate interface devices 110a-110z, one or more public ledger systems 120a-120z, and a platform provider system 130 for communicating over a network 140.

As described herein, an interface device and a system can include any type of processor-enabled device such as a computer, tablet, PDA, smart phone, and other such components, for example, that can be operated by a human user.

As described herein, the user interface devices 101 can be used by registered users of the system to upload, buy, sell and manage subject property ownership through the system. As such, each user interface device can also be referred to as a seller interface device and a buyer interface device when used by a registered user to provide a subject property to the system and purchase fractional ownership of a subject property via the system.

As described herein, the real estate interface devices 110 can be communicatively linked with and/or operated by any number of other groups or agencies involved in the research, transfer, and/or recording, of real estate transactions. Several nonlimiting examples include but are not limited to clerk(s) of courts, property appraisers, county records department, title companies, insurance companies, mortgage companies, and/or tax collectors among others, for example.

As described herein, a public ledger system 120a-120z can include, comprise or consist of a cryptocurrency exchange system utilizing blockchain record-keeping technology. Of course, any number of other such record keeping ledgers, databases and systems can be used herein to accommodate, record, or otherwise memorialize a transfer in ownership interest of a subject property in the manner described below.

The platform provider system 130, according to one embodiment, can include one or more individual computing devices 135 that can be connected to one or more databases 136 on which various portions of the method can be performed.

One example of a database 136 for use herein can include one or more independent storage devices that can function to receive and store information for the performance of the method steps, and/or records pertaining to the purchase and sale of fractional ownership interests of subject property using the system. Several nonlimiting examples include various types of computer-readable storage mediums, such as semiconductor memory devices, e.g., DRAM, SRAM, EPROM, EEPROM, and flash memory devices, magnetic disks, e.g., internal hard disks or removable disks, for example.

The platform provider system 130 can function to provide a central hub for controlling the communication between the described interface devices and systems through any number of different mediums such as the above noted website, for example, along with any number of secure and/or encrypted messaging and communication protocols. In this regard, one or more of the individual computing devices described herein as the platform provider system can comprise a web server, an email server, a communication server, and so forth, or the system can employ one or more single server-type devices which function to handle each of these processes.

The platform system 130 can also include functionality for providing one or more mobile applications 15 that can be downloaded onto a user interface device. In this regard, the system can provide or generate any number of different display screens on each of the interface devices in order to provide users and sellers with the ability to view, research, buy and sell subject properties, as described above. To this end, portions of the above described methodology can be implemented as a computer program product, which can be written in any form of computer or programming language for use with any form of processor enabled device.

Owing to the sensitive nature of the information to be shared across the system components, one or more of the platform system servers 135, and/or traditional real estate interface devices 110, can be constructed as a purpose-built device having dedicated and password protected internal or external storage mediums. These purpose-built devices can further include secure network interfaces to ensure that the purpose-built non-generic processor enabled devices perform the below described methodology in a completely secure manner that cannot be achieved through the use of off-the-shelf hardware. Such a feature being beneficial to ensure the transfer of ownership and recording of the same is performed in accordance with industry best practices.

In various embodiments, the network 140 is a transmission medium that facilitates any form of digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), Bluetooth, WiFi, or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

The following methods for using the real estate technology platform are designed to allow any number of individuals to research, purchase and/or sell fractional ownership of a subject property such as commercial real estate, for example, that eliminates the traditional broker costs by providing a peer to peer transfer mechanism utilizing blockchain recording. The methods also allowing original seller(s) owning an entire subject property to list the same onto the platform in order to profit through fractional sales of the property.

To begin, each user can create a user account via the platform provider server to enable them to utilize the system functionality. In one embodiment, the account information for each created user account can be maintained by the database 136, and can include, for example, information such as personal information, username, password, email address, physical address, and financial information (e.g., bank information, digital currency information, and links for accessing funds from the same).

The platform provider can use any number of internal or third-party systems to perform user authentication such as auditing the source of funds and performing background checks and identity verification prior to granting a user access to system functionality. The registration process can also include assigning each user account a vault/wallet wherein financial information can be stored and available to the user via their selected interface device.

Of course, many other steps may be included within the registration process. In either instance, upon completing the registration process, each user can be granted access to the digital wallet and can utilize the system to buy, sell and manage subject properties in the manner described below.

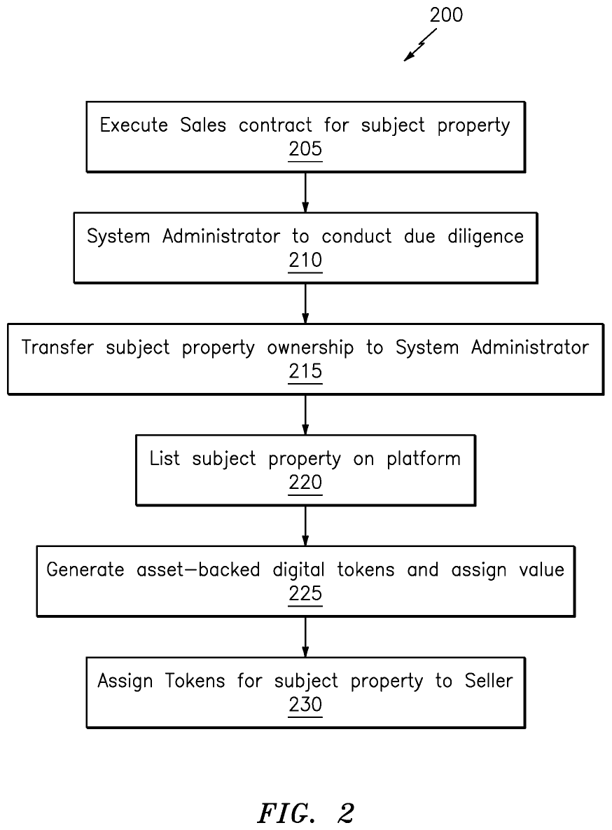

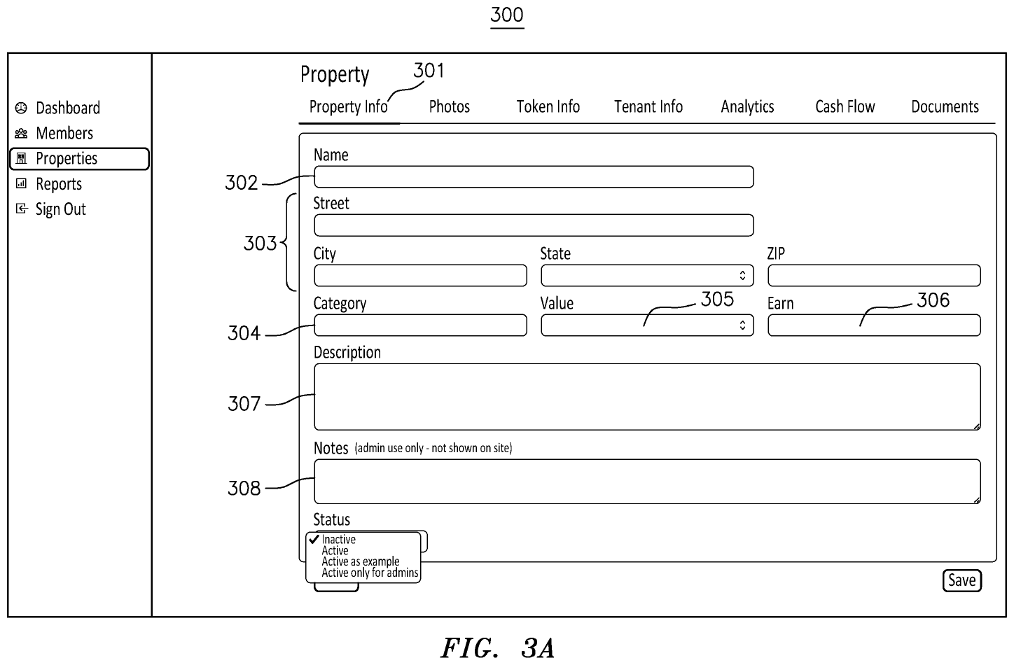

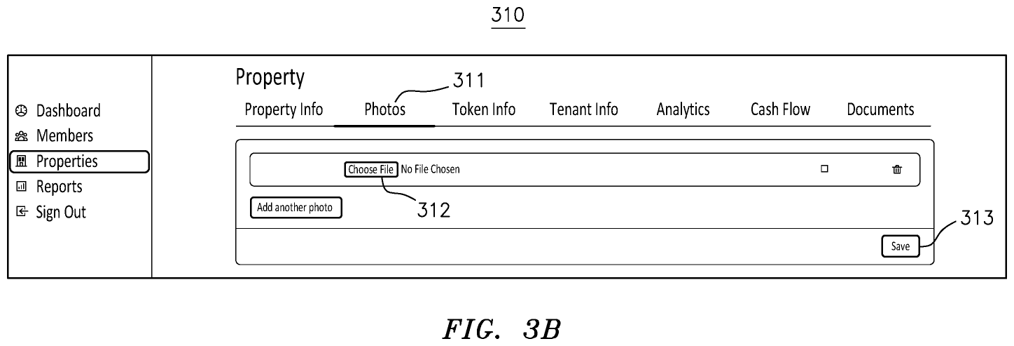

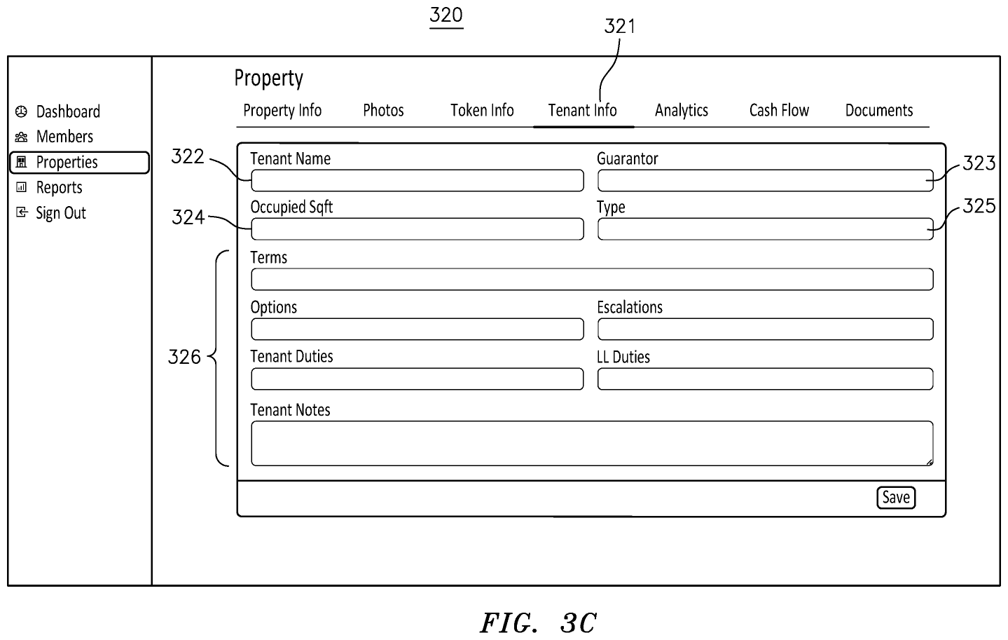

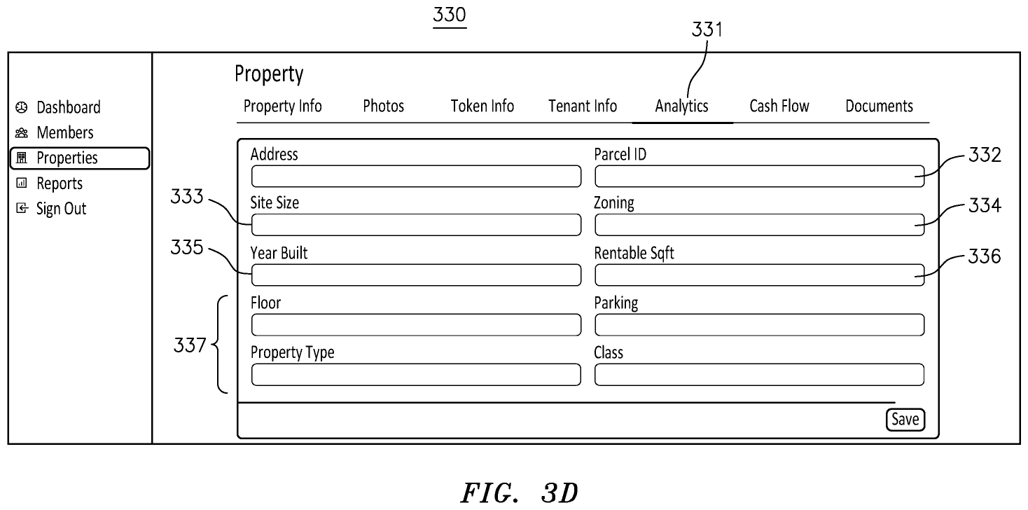

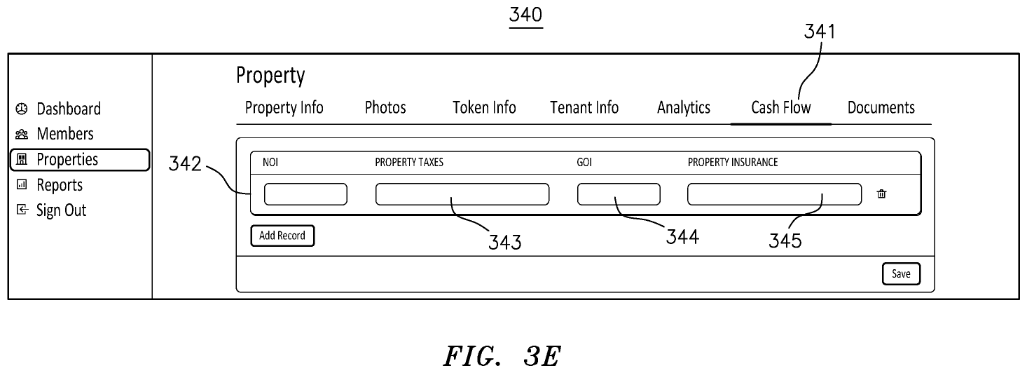

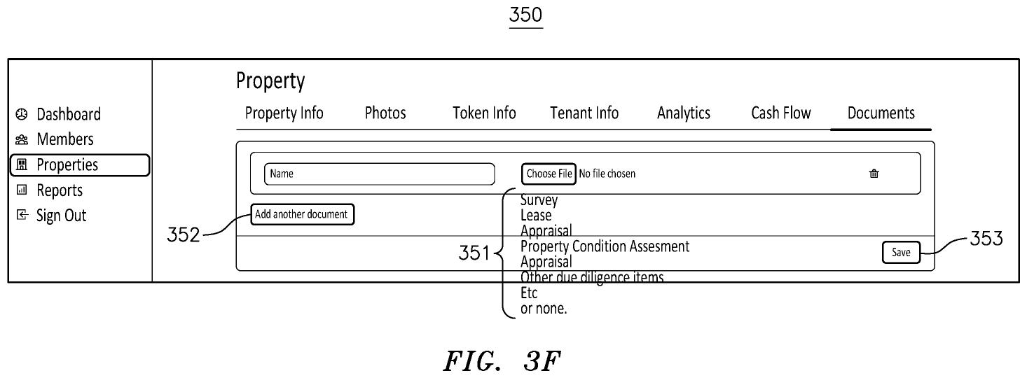

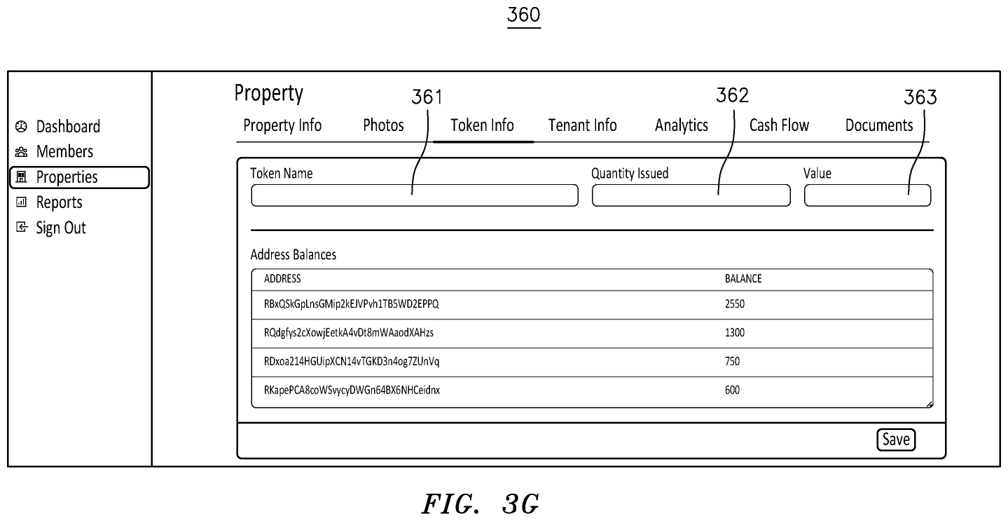

A method 200 of selling and listing subject property on the system 100 will now be described with respect to FIG. 2. Moreover, several exemplary presentation screens which can be generated by the system are presented with respect to FIGS. 3A-3G. Although described below with respect to particular steps and screens, this is for illustrative purposes only, as the methodology described herein can be performed in a different order than shown, and the presentation screens can include any number of additional information and features.

As shown at FIG. 2, the method 200 can begin at step 205 wherein the registered user can enter into a contract to sell a subject property with the platform provider (e.g., FREXA or a FREXA affiliate/holding company, for example) or other entity chosen by the platform provider as the buyer. Next, the method can proceed to step 210 wherein the platform provider can perform their due diligence e.g., receive and review pertinent documents such as current property tenants, outstanding loans, and the like.,

Next, the method can proceed to step 215 wherein the subject property can undergo a real estate closing in accordance with the laws and regulations of the local where the subject property is located. The closing can function to transfer the legal ownership of the subject property from the registered user (e.g., seller) to the platform provider. In various embodiments, the platform provider can take title to the subject property, and within that title grant ownership rights all holders of tokens to be assigned to the property by the system. This can be accomplished through one or more processes such as assigning individual deeds to token holders, through a partnership shares/units arrangement and/or via any number of other legally enforceable processes.

Upon execution of the closing, the method can proceed to step 220 wherein information about the subject property can be listed within the system, and made available for viewing and research by other registered users in deciding whether or not to purchase fractional ownership of the subject property. To this end, FIGS. 3A-3F illustrate several exemplary property information interface screens that can be generated by the platform provider server 135 to allow a designated user to upload pertinent information about the subject property. The information and presentation screens shown are provided for exemplary purposes only and are not limiting in nature.

In various embodiments, the platform provider 130 can generate a property information interface screen 300 for receiving property information 301 such as the property name 302, address 303, category 304, value 305, earnings 306, a property description 307 and/or various notes 308 for internal viewing by platform provider staff, for example. The system can also generate interface screen 310 for allowing photographs 311 of the property to be uploaded 312 and saved 313 onto the system database for viewing by system users. The system can also generate interface screen 320 for receiving property tenant information 321 such as tenant name 322, financial guarantor 323, occupied space 324 and type 325 along with other pertinent information 326, for example.

The system can also generate interface screen 330 for receiving property analytics 331 such as the parcel ID 332, site size 333, zoning 334, year build 335 rentable sq. ft. 336, and building statistics 337, for example. The system can also generate interface screen 340 for receiving property cash flow details 341 such as the subject properties' Net Operating Income (NOI) 342, Taxes 343, Gross Operating Income (GOI) 344 and/or insurance costs 345, for example. The system can also generate interface screen 350 for allowing documents 351 such as the subject property survey, Lease(s), appraisal, property conditions and the like to be uploaded 352 and saved 353 onto the system database for viewing by system users.

After the subject property information has been uploaded to the system, the method can proceed to step 225 wherein ownership shares can be generated by the platform provider in the form of asset-based digital tokens. FIG. 3G illustrates an exemplary token generation and assignment interface screen 360 that can be generated by the platform provider server 135. As shown, the screen can include options for assigning a token name 361, a quantity of tokens issued 362 and individual token value 363.

The number and value of each token generated for an uploaded subject property can be determined by the platform provider, and can be commensurate with the value of the subject property itself, less any fees associated with acquiring and listing the property within the system. For example, an uploaded subject property worth $100,000 may be assigned 100 tokens each having a value of $1,000, or 1000 tokens each having a value of $100, for example.

Finally, the method can proceed to step 230 where the digital tokens for the subject property can be assigned to the user wallet of the original seller of the subject property. As other users purchase tokens and become fractional owners, the purchased tokens will be transferred from the original seller's account to the new owner, thus decreasing the ownership interest of the original seller with each sale. In one embodiment, each purchase can be in the form of a crypto contract that is tied to a blockchain ledger that records the changes in ownership through sales of the tokens.

Although described above as using a specific type of digital token and ledger system, this is for illustrative purposes only. To this end, any number of other types of digital currency and/or record keeping systems can be utilized in order to facilitate and record fractional transfers of ownership of a subject property via the system platform.

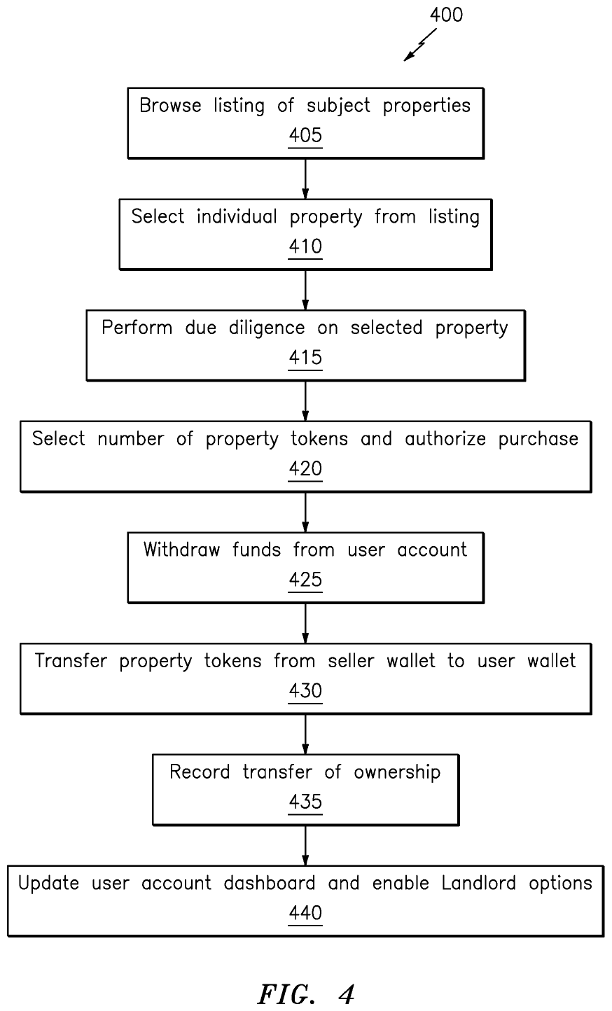

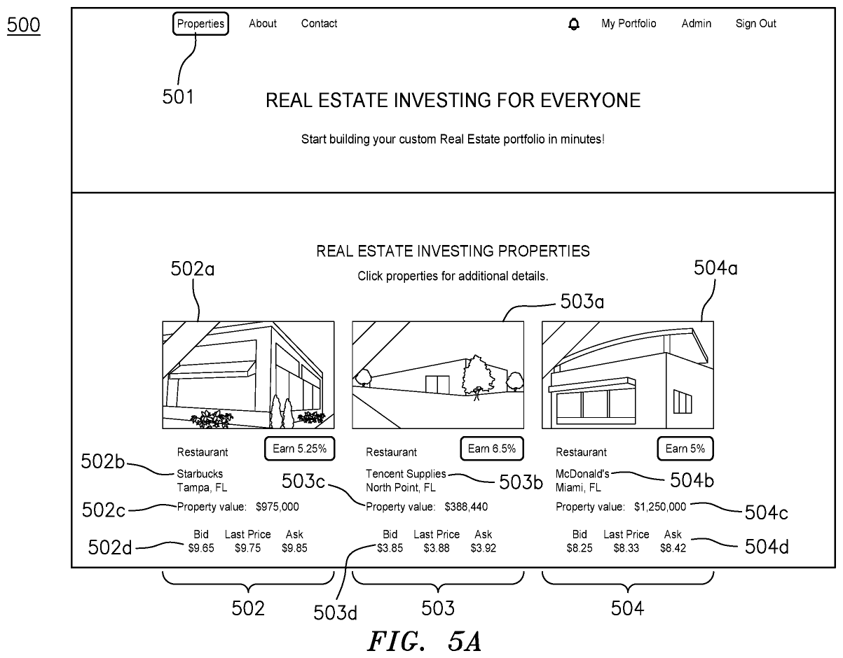

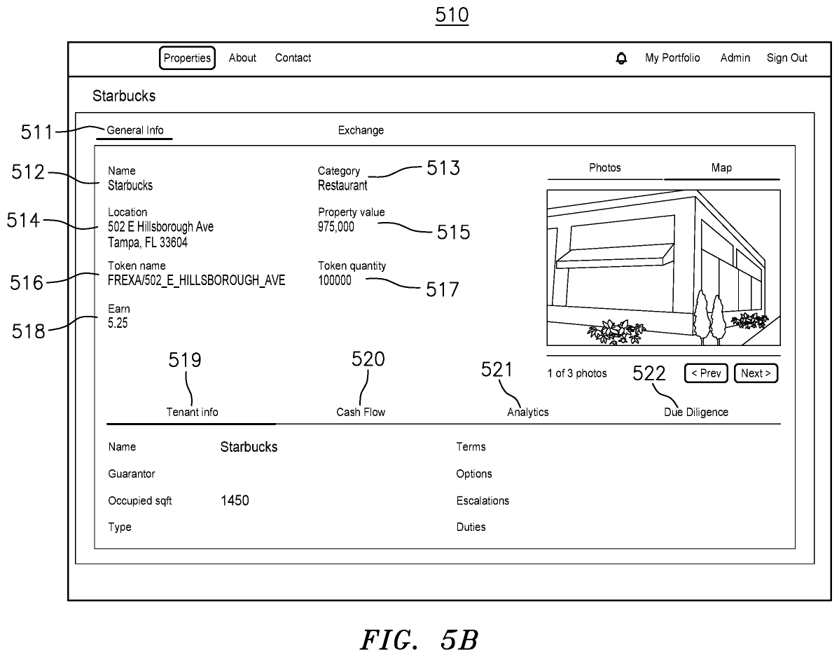

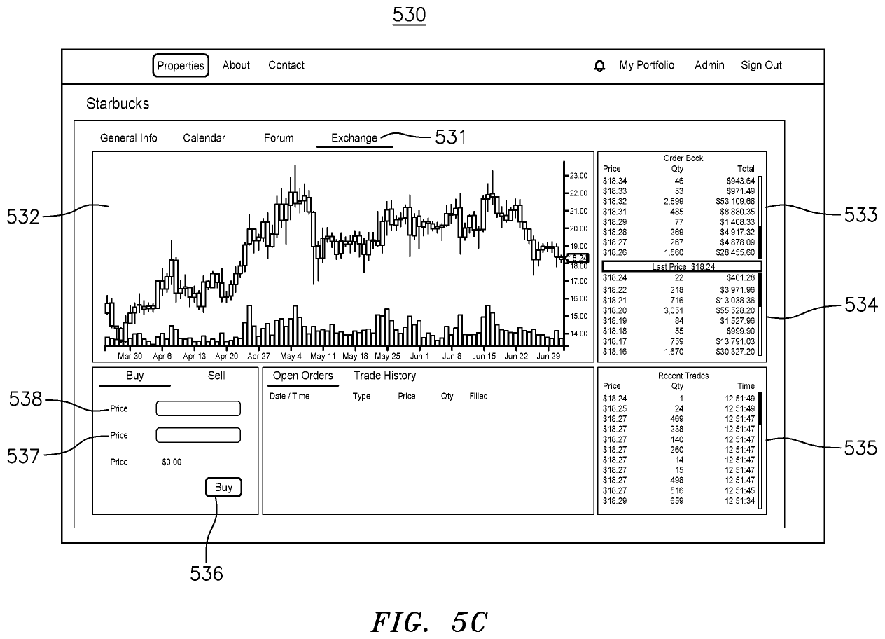

A method 400 of purchasing fractional ownership of a subject property utilizing the system 100 will now be described with respect to FIG. 4. Moreover, several exemplary presentation screens which can be generated by the system are presented with respect to FIGS. 5A-5C. Although described below with respect to particular steps and screens, this is for illustrative purposes only, as the methodology described herein can be performed in a different order than shown, and the presentation screens can include any number of additional information and features.

As shown at FIG. 4, the method 400 can begin at step 405 wherein a registered user can browse through a listing of available subject properties found on the system database. The user can be provided with options for selecting and viewing properties based on any number of chosen criteria such as geographic location, industry, property income, number of tenants and the like.

FIG. 5A illustrates one embodiment of an exemplary property listing presentation screen 500 that can be generated by the platform provider server 135 in response to a user selecting a Property Search tab 401 from a user menu. As shown, the presentation screen 500 can provide a listing of individual properties 502, 503 and 504, for example, having digital tokens that are currently available to be purchased. In the illustrated example, each listing can be provided as a snapshot view, and can include a representative Photograph 502a, 503a 504a, Name 502b, 503b, 504b, Value 502c, 503c, 504c, and token purchase information 502d, 503d 504d such as the current bid price, list price and ask price, for example.

Upon viewing the listing of properties, the method can proceed to step 410 where the user can select an individual property for closer inspection and can perform due diligence at step 415 to determine if the subject property fits their particular investment strategy.

FIG. 5B illustrates an exemplary property information screen 510 for providing general information 511 about the selected property. As shown, presentation screen 510 can include, for example, details such as the property name 512, category 513, location 514, value 515, token name 516, number of tokens issued 517, and a statistical earnings number. The user can also be provided with options for instructing the system server to provide additional property details such as the property tenant information 519, cash flow 520, analytics 521 and to view property documents 522. Each of these options 511-522 corresponding to the property information that was uploaded at step 220 (see FIGS. 3A-3F).

In one embodiment the system can utilize a liquidity pool base method and system. In addition, the system can also utilize an order book method and system. To this end, FIG. 5C illustrates an exemplary property exchange screen 530 for providing exchange pricing information 531 about the selected property. In various embodiments, presentation screen 530 can include a graphical representation 532, order book listing 533, last price listing 534 and recent trade history 535 of the subject property tokens. Additionally, presentation screen 530 can provide the user with options to purchase 536 any number of subject property tokens 537 from the exchange at a particular price 538, such as the current list price, for example.

At step 420, the user can determine the number of tokens they wish to purchase and can instruct the platform provider to execute the transaction (e.g., clicking on the buy tab 536). At step 425, funds totaling the value of the selected number of property tokens can be withdrawn from the user account by the platform provider. At step 430, the selected number of property tokens can be removed from the digital wallet of the seller and can be deposited into the digital wallet of the buyer, and at step 435 the transfer of token ownership can be recorded by the blockchain ledger. Finally, at step 440 the user dashboard can be updated to reflect the successful purchase, and the user can be provided with landlord options for the subject property.

Because property tokens are legally tied to property ownership via a recorded deed or other such instrument, token holders become Landlords of the subject properties, and have rights proportional to their individual ownership percentage. To this end, the system 100 includes functionality for providing token owners with options for overseeing the ongoing business aspects of their subject properties. Several nonlimiting examples of such options include, but are not limited to providing token owners with the ability to managing building operations (e.g., building janitorial services, leasing agents, maintenance personnel), vote for building actions (e.g., renovations, allowance or rejection of potential tenants), and collecting rental income if cash flow is in place via lease agreements with property tenants.

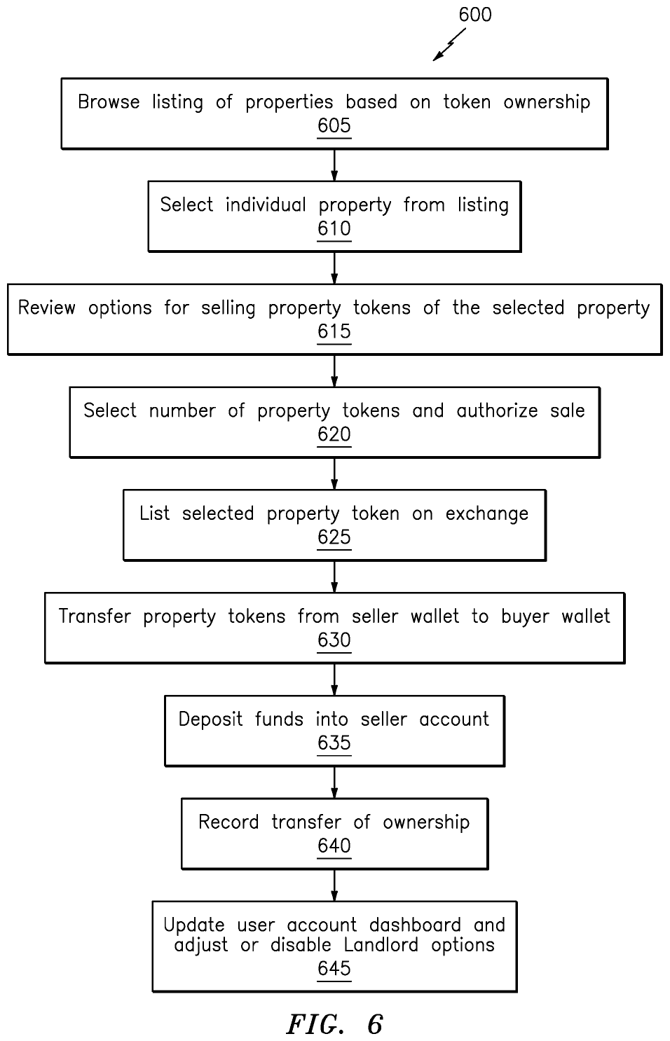

A method 600 of selling fractional ownership of a subject property utilizing the system 100 will now be described with respect to FIG. 6. As shown, the method 600 can begin at step 605 wherein a user can navigate to their portfolio page where they can browse through a listing of properties for which they own property tokens. Depending on the number of property tokens the user owns, the user can be provided with options for selecting and viewing properties based on any number of chosen criteria such as geographic location, industry, property income, number of tenants and the like.

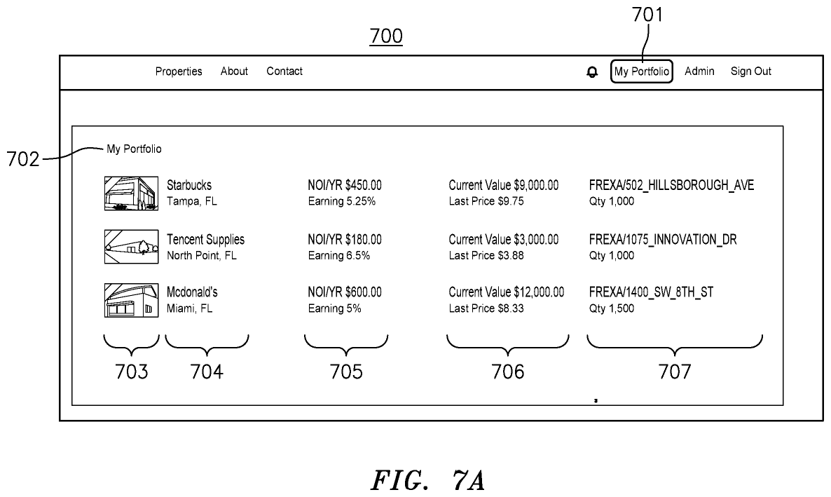

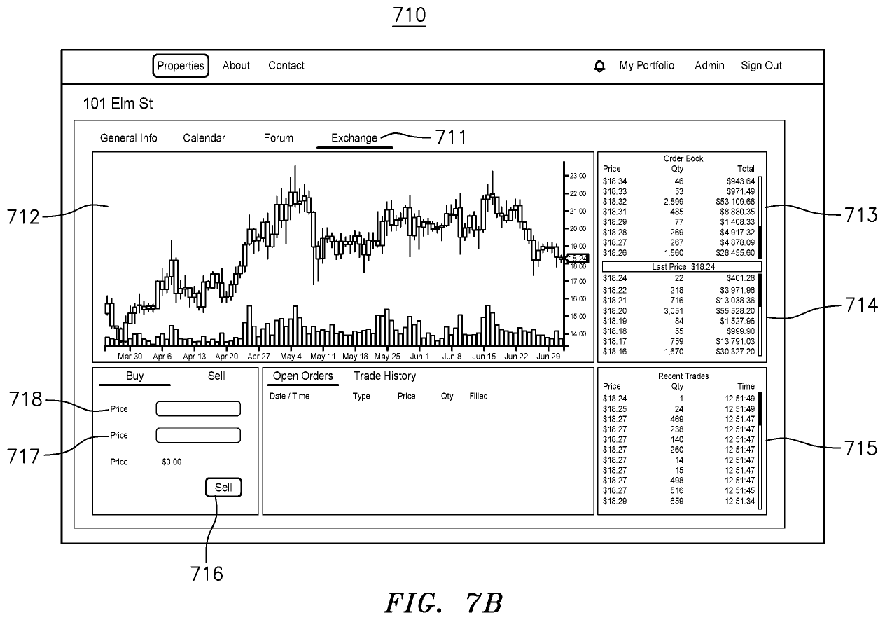

FIG. 7A illustrates one embodiment of an exemplary portfolio presentation screen 700 that can be generated by the platform provider server 135 in response to a user selecting the My Portfolio tab 701 from the user menu. As shown, the presentation screen 700 can provide a listing of each individual property 702 for which the user currently owns property tokens. In the illustrated example, each listing can be provided as a snapshot view, and can include a representative Photographs 703, property names 704, current earnings 705, current property values 706 and current token information 707, for example.

Upon viewing the listing of properties, the method can proceed to step 610 where the user can select an individual property and can be provided with additional information and options for selling the same at step 615.

FIG. 7B illustrates an exemplary property exchange screen 710 for providing exchange pricing information 711 about the selected property. In various embodiments, presentation screen 710 can include a graphical representation 712, order book listing 713, last price listing 714 and recent trade history 715 of the subject property tokens. Additionally, presentation screen 710 can provide the user with options to sell 716 any number of their subject property tokens 717 on the exchange at a particular price 718, such as the current list price, or via a seller established asking price, for example.

At step 620, the user can determine the number of property tokens for the selected property that they wish to sell from their digital wallet, and at step 625 can instruct the platform provider to list the selected number of tokens on the exchange. The tokens can remain listed on the exchange until such time that another registered user purchases one or more of the offered tokens.

Upon receiving an order to buy one or more of the listed property tokens from another registered user, the method can proceed to step 630 where the platform provider can remove the selected number of property tokens from the digital wallet of the seller, and deposit the same into the digital wallet of the buyer. At step 635 funds totaling the value of the sold property tokens can be deposited into the seller's user account by the platform provider, at step 640 the transfer of token ownership can be recorded by the blockchain ledger. Finally, at step 645 the user dashboard can be updated to reflect the successful sale, and the user landlord options can be removed or adjusted in accordance with the resulting ownership percentage.

Although described above as a means for buying and selling fractional ownership of property, the inventive system also allows users to profit by holding their property tokens over time. To this end, users can derive value through capital appreciation of the subject properties and via cash flow from property tenants in proportion to their ownership percentage.

Also, individual users can swap, trade or otherwise exchange ownership interests in subject properties by exchanging tokens from a first user with tokens from a second user, thus providing a token to token exchange of real property. Such transactions being duly recorded by the distributed ledger.

Accordingly, the above described system and method provide a novel and innovative means for allowing individuals to invest in real property without the drawbacks or expenses of using a traditional real estate model.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for transferring fractional ownership interests of real property over a network, said method comprising:
establishing communication between a plurality of user interface devices and a platform provider system over a network, wherein at least one of the plurality of user interface devices is operated by an original seller;
transferring a subject property from the original seller to a platform provider representative;
generating, via the platform provider system, a plurality of digital tokens that are assigned to the subject property;
depositing the plurality of generated digital tokens to a digital wallet of the original seller.

2. The method of claim 1, wherein the subject property comprises a piece of real property, and each of the generated digital tokens comprise asset-based digital tokens.

3. The method of claim 1, wherein said selling a subject property comprises:
transferring legal title of the subject property, and recording a property deed.

4. The method of claim 3, further comprising:
executing, via the platform provider representative, one of an individual deed or a partnership share to each owner of one of the plurality of generated digital tokens for the subject property.

5. The method of claim 1, wherein the plurality of digital tokens assigned to the subject property comprise a value that is equal to a cash value of the subject property.

6. The method of claim 1, further comprising:
recording, via a blockchain ledger, the deposit of the plurality of generated digital tokens to the original seller.

7. The method of claim 1, further comprising:
uploading, via the platform provider system, information about the subject property onto a platform provider database.

8. The method of claim 7, wherein said information about the subject property includes a property name, a property address, a property value, a property description, and a property photograph.

9. The method of claim 7, wherein said information about the subject property comprises property tenant information that includes a property tenant name, a financial guarantor, and an identification of occupied space by each property tenant.

10. The method of claim 7, wherein said information about the subject property comprises due diligence documents that include a property survey, a property appraisal, and a property condition report.

11. The method of claim 7, further comprising:
displaying the uploaded information to the plurality of user interface devices.

12. The method of claim 1, further comprising:
providing, via the platform provider server, options to purchase at least one of the plurality of generated digital tokens using a buyer interface device.

13. The method of claim 12, further comprising:
receiving, via the buyer interface device, an instruction to buy at least one of the plurality of generated digital tokens.

14. The method of claim 13, further comprising:
transferring, via the platform provider system, funds from a user account of the buyer interface device.

15. The method of claim 14, further comprising:
transferring, via the platform provider system, the at least one generated digital token from the digital wallet of the original seller, to a digital wallet of the user of the buyer interface device.

16. The method of claim 15, further comprising:
recording, via a blockchain ledger, the transfer of the at least one generated digital token from the original seller to the user.

17. The method of claim 16, further comprising:
providing, via the buyer interface device, landlord options for managing the subject property for which the at least one generated digital token is assigned.

18. The method of claim 17, wherein the landlord options include at least one of managing building operations, or voting for building actions.

19. The method of claim 17, wherein the landlord options includes collecting rental income from a tenant of the subject property for which the at least one generated digital token is assigned.

20. The method of claim 16, further comprising:
providing, via the buyer interface device, options to sell the at least one generated digital token to another system user.
